(19) United States
(12) Patent Application Publication
(10) Pub. No.: US 2011/0056384 A1
(43) Pub. Date: Mar. 10, 2011

(54) Humidity control and ventilation system

(75) Inventor: Shigeru Kadota, Obu-city (JP)

(73) Assignee: DENSO CORPORATION, Kariya-city (JP)

(21) Appl. No.: 12/807,595

(22) Filed: Sep. 8, 2010

(30) Foreign Application Priority Data
Sep. 9, 2009 (JP) 2009-208351

(51) Int. Cl. F24F 3/14; B01F 3/04

(52) U.S. Cl. 96/407; 236/44 A

(57) ABSTRACT

A humidity control and ventilation system for a building with an absorption-type humidity controller includes an air supply passage, air discharge passage and a processing unit. The air supply passage is configured to conduct intake air from an exterior inlet port, which is located at an outside of the building, to an interior outlet port, which is located at an inside of the building. The processing unit is inserted in the air supply passage. The air supply passage includes an intake duct that is located between the processing unit and the interior outlet port, and the intake duct includes a vertically extending section, which extends in a vertical direction to create an upflow of the intake air conducted from the processing unit toward the interior outlet port.

### CROSS REFERENCE TO RELATED APPLICATION

The present application is based on Japanese Patent Application No. 2009-208351 filed on Sep. 9, 2009, the disclosure of which is incorporated herein by reference.

### FIELD OF THE INVENTION

The present invention relates to a humidity control and ventilation system which conditions humidity of an internal space and performs ventilation.

### BACKGROUND OF THE INVENTION

As a related art, a humidity control and ventilation system is disclosed in JP-A-10-61979. The humidity control and ventilation system includes an intake passage for conducting external air into an internal space, an exhaust passage for exhausting internal air into an external space, a dehumidifying unit in which hygroscopic liquid absorbs moisture from air flowing through the intake passage for dehumidification, and a regenerating unit in which moisture is released from hygroscopic liquid into air flowing through the exhaust passage to regenerate the hygroscopic liquid.

In the dehumidifying unit, a moisture permeable membrane is placed between the hygroscopic liquid and intake air. Since moisture is transferred to the hygroscopic liquid from the intake air through the moisture permeable membrane, the hygroscopic liquid is prevented from mixing into the intake air and flying into the internal space.

In the humidity control and ventilation system of the above-described related art, the moisture permeable membrane that separates the intake air from the hygroscopic liquid for preventing the flying of the hygroscopic liquid is used. Thus, for securing sufficient humidity control performance, there is a problem that a configuration of a humidity control and ventilation system having a dehumidifying unit as a main part becomes complex.

### SUMMARY OF THE INVENTION

The present invention addressed the above disadvantage.

According to the present invention, there is provided a humidity control and ventilation system for a building, which includes an air supply passage configured to conduct intake air from an exterior inlet port, which is located at an outside of the building, to an interior outlet port, which is located at an inside of the building; an air discharge passage configured to conduct discharge air from an interior inlet port, which is located at the inside of the building, to an exterior outlet port, which is located at the outside of the building; and a processing unit that is disposed in the air supply passage and stores a hygroscopic liquid. The processing unit performs at least one of: an absorbing process, in which the hygroscopic liquid absorbs moisture from the intake air conducted through the air supply passage; and a releasing process, in which the hygroscopic liquid releases moisture into the intake air conducted through the air supply passage. The air supply passage includes an intake duct that is located between the processing unit and the interior outlet port. The intake duct includes a vertically extending section, which extends in a vertical direction to create an upflow of the intake air conducted from the processing unit toward the interior outlet port.

Accordingly, the humidity control and ventilation system includes the vertically extending section to create the upflow of the intake air conducted from the processing unit toward the interior outlet port. Thus, even if droplets of the hygroscopic liquid are taken in the intake air when passing through the processing unit, the droplets of the hygroscopic liquid can be prevented from reaching the interior outlet port by the gravity. Therefore, flying of the hygroscopic liquid can be suppressed by the simple configuration, in which the vertically extending section is arranged in the intake duct from the processing unit to the interior outlet port.

Moreover, according to claim 10, the humidity control and ventilation system includes a processing-unit circulating means configured to circulate the hygroscopic liquid in the processing unit to facilitate the absorbing process and the releasing process, and a regenerating-unit circulating means configured to circulate the hygroscopic liquid in the regenerating unit to facilitate the regenerating process. At least one of the processing-unit circulating means and the regenerating-unit circulating means is stopped when a difference of enthalpies or physical quantities corresponding to the enthalpies between external air and internal air is equal to or lower than a predetermined value based on a temperature and humidity of an external space and a temperature and humidity of an internal space.

A ventilation system, which has a heat exchanger at an intersection of an intake passage and an exhaust passage and performs heat exchange between intake air from an external space to an internal space and discharge air from the internal space to the external space, is conventionally known. In the ventilation system, bypass passages that bypass the heat exchanger are formed in each of the intake passage and the exhaust passage, and a damper for opening and closing the bypass passages is arranged. When heat exchanger is not necessary in the spring season and the fall season, for example, the bypass passages are opened by the damper such that the intake air and the discharge air flow so as to bypass the heat exchanger (refer to JP-Y2-55-2367).

Since on-off of a heat exchange function between the intake air and the discharge air is switched in the above-described ventilation system, two bypass passages and the damper for opening and closing the bypass passages are necessary. Thus, the configuration of the ventilation system may become complex. However, according to the configuration of claim 10, on-off of a heat exchange function can be switched with a simple configuration.

### BRIEF DESCRIPTION OF THE DRAWINGS

The above and other objects, features and advantages of the present invention will become more apparent from the following detailed description made with reference to the accompanying drawings. In the drawings:

FIG. 1 is a system configuration diagram showing an air-conditioning system including a humidity control and ventilation system according to a first embodiment of the present invention;

FIG. 2A is a schematic diagram showing a configuration of a main part of the humidity control and ventilation system;

FIG. 2B is a block diagram showing a control system of the humidity control and ventilation system;

FIG. 3 is a graph showing a relation between a droplet diameter and a droplet fall velocity of lithium chloride aqueous solution as hygroscopic liquid of the humidity control and ventilation system;

FIG. 4A is a schematic diagram showing a flow in a vertical duct when droplets of the hygroscopic liquid mix into air, in the case where Reynolds number Re is smaller than critical Reynolds number;

FIG. 4B is a schematic diagram showing a flow in the vertical duct when the droplets of the hygroscopic liquid mix into air, in the case where Reynolds number Re is larger than critical Reynolds number;

FIG. 5A is a table showing a relation between a total floor area of a building and a set ventilatory volume;

FIG. 5B is a table showing a relation between a tube diameter of the vertical duct and an in-tube flow velocity;

FIG. 5C is a table showing a relation between the tube diameter of the vertical duct and Reynolds number Re;

FIG. 6 is a graph showing annual data of external temperature and humidity in Nagoya;

FIG. 7 is a system configuration diagram showing an air-conditioning system including a humidity control and ventilation system according to a second embodiment of the present invention;

FIG. 8 is a system configuration diagram showing an air-conditioning system including a humidity control and ventilation system according to a third embodiment of the present invention;

FIG. 9 is a system configuration diagram showing an air-conditioning system including a humidity control and ventilation system according to a fourth embodiment of the present invention;

FIGS. 10A to 10C are schematic diagrams showing connection structures of an intake duct or an air-conditioning intake duct to multiple interior outlet ports; and

FIG. 11 is a schematic diagram showing a configuration of a main part of a humidity control and ventilation system according to another embodiment of the present invention.

### DETAILED DESCRIPTION OF THE PREFERRED EMBODIMENTS

Hereinafter, embodiments of the present invention will be described with reference to drawings. In the respective embodiments, the component which is the same with that in the antecedent embodiment is designated by the same reference numeral and a description thereof will not be repeated. In the respective embodiments, if only a part of the configuration is described, the other part of the configuration is the same with that described in the antecedent embodiment. The present invention is not limited to the combinations described concretely in the respective embodiments. If there is no contradiction in the combinations, the embodiments can be partially combined.

### First Embodiment

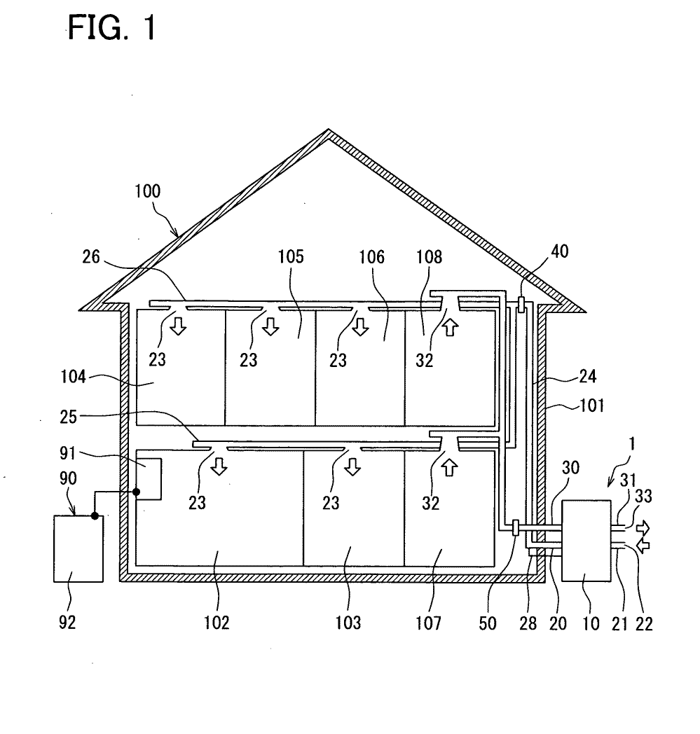

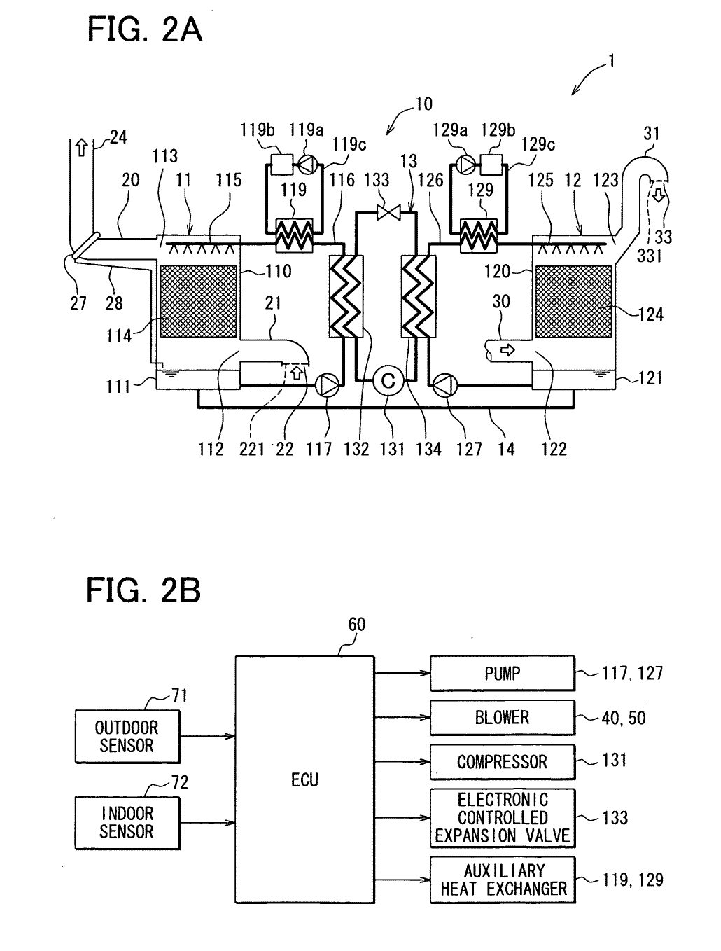

FIG. 1 is a system configuration diagram showing an air-conditioning system including a humidity control and ventilation system 1 according to the first embodiment of the present invention. FIG. 2A is a schematic diagram showing a configuration of a main part of the humidity control and ventilation system 1.

As shown in FIG. 1, the humidity control and ventilation system 1 arranged in a building 100 includes an absorption-type humidity controller 10, an intake pipe 21, an intake duct 20, an exhaust duct 30, and an exhaust pipe 31. The humidity controller 10 uses, for example, lithium chloride aqueous solution as hygroscopic liquid. The intake pipe 21 has an exterior inlet port 22 at an upstream end thereof and conducts external air into the humidity controller 10. The intake duct 20 has an interior outlet port 23 at a downstream end thereof and conducts air, which is humidity controlled by the humidity controller 10, into an internal space. The exhaust duct 30 has an interior inlet port 32 at an upstream end thereof and conducts internal air to the humidity controller 10. The exhaust pipe 31 has an exterior outlet port 33 at a downstream end thereof and conducts air, which has passed through the humidity controller 10, to an external space. The humidity controller 10 is placed at an appropriate external space, for example. The exterior inlet port 22 and the exterior outlet port 33 are located at an outside of the building 100, and the interior outlet port 23 and the interior inlet port 32 are located at an inside of the building 100.

As shown in FIG. 2A, the humidity controller 10 includes a processing unit 11, a regenerating unit 12, and a heat pump unit 13. The processing unit 11 can perform either an absorbing process, in which the hygroscopic liquid absorbs moisture from intake air, or a releasing process, in which the hygroscopic liquid releases moisture into the intake air. The regenerating unit 12 is configured such that hygroscopic liquid therein releases moisture into discharge air when the processing unit 11 performs the absorbing process and the hygroscopic liquid therein absorbs moisture from the discharge air when the processing unit 11 performs the releasing process. That is, the regenerating unit 12 can perform a regenerating process that regenerates moisture absorbing-releasing capacity of the hygroscopic liquid. A processing capability of the processing unit 11 can be easily maintained. The heat pump unit 13 is a device for transferring heat between the processing unit 11 and the regenerating unit 12.

An outer hull of the processing unit 11 is configured by a processing-unit case 110 made of resin, for example. The processing-unit case 110 has a liquid tank 111, in which the hygroscopic liquid is stored, at a bottom portion thereof. An air inlet port 112 opens in a side surface portion of the processing-unit case 110 above a liquid level of the hygroscopic liquid. The intake pipe 21 is connected to the processing-unit case 110 such that the air inlet port 112 is located at a downstream end of the intake pipe 21. In order to prevent a foreign object such as an insect from entering the processing-unit case 110, an intake, air filter 221 is arranged in the intake pipe 21 (in the present embodiment, at the upstream end of the intake pipe 21). An air outlet port 113 opens in the side surface portion of the processing-unit case 110 above the level of the air inlet port 112. The intake duct 20 is connected to the processing-unit case 110 such that the air outlet port 113 is located at an upstream end of the intake duct 20.

A processing element 114 is arranged inside the processing-unit case 110 at a position above the air inlet port 112 and below the air outlet port 113. The processing element 114 is configured by laminating multiple nonwoven compression boards made of cellulose fiber, which are formed to have a corrugated shape. The processing element 114 is placed in the processing-unit case 110 such that an extending direction of a peak or a valley of the corrugated shape is along a longitudinal direction (i.e., a vertical direction) and the processing element 114 covers the entire area of the processing-unit case 110 in a lateral direction. The processing element 114 is impregnated with the hygroscopic liquid and the hygroscopic liquid falls through the processing element 114. Air flows upward through a space between the laminated boards of the processing element 114. According to the above configuration, the contact area between the falling hygroscopic liquid and the air flowing upward becomes large, and thereby the processes can be performed with high efficiency.

A liquid nozzle 115 for dripping the hygroscopic liquid toward the processing element 114 is arranged inside the processing-unit case 110 at a position above the processing element 114. A circulation circuit 116 for sending the hygroscopic liquid in the liquid tank 111 to the liquid nozzle 115 is formed outside the processing-unit case 110. A circulation pump 117, which is used as a processing-unit circulating means, for circulating the hygroscopic liquid is arranged in the circulation circuit 116. Moreover, a heat exchanger 132, which will be described below, and an auxiliary heat exchanger 119 are arranged in the circulation circuit 116 at a downstream portion of the circulation pump 117. The auxiliary heat exchanger 119, a pump 119a and a heat source 119b are arranged in an auxiliary circuit 119c. A medium in the auxiliary circuit 119c is cooled or heated by the heat source 119b. The medium circulates in the auxiliary circuit 119c by the pump 119a. By the auxiliary heat exchanger 119, the hygroscopic liquid is heat exchanged with the medium. For example, one of cool water, a refrigerant, or hot water is used as the medium in the auxiliary circuit 119c.

The configuration of the regenerating unit 12 is similar to that of the processing unit 11.

An outer hull of the regenerating unit 12 is configured by a regenerating-unit case 120 made of resin, for example. The regenerating-unit case 120 has a liquid tank 121, in which, the hygroscopic liquid is stored, at a bottom portion thereof. An air inlet port 122 opens in a side surface portion of the regenerating-unit case 120 above a liquid level of the hygroscopic liquid. The exhaust duct 30 is connected to the regenerating-unit case 120 such that the air inlet port 122 is located at a downstream end of the exhaust duct 30. An air outlet port 123 opens in the side surface portion of the regenerating-unit case 120 above the level of the air inlet port 122. The exhaust pipe 31 is connected to the regenerating-unit case 120 such that the air outlet port 123 is located at an upstream end of the exhaust pipe 31. In order to prevent a foreign object such as an insect from entering the regenerating-unit case 120, an exhaust air filter 331 is arranged in the exhaust pipe 31 (in the present embodiment, at the downstream end of the exhaust pipe 31).

A regenerating element 124 is arranged inside the regenerating-unit case 120 at a position above the air inlet port 122 and below the air outlet port 123. The configuration of the regenerating element 124 is similar to that of the processing element 114. The regenerating element 124 is arranged inside the regenerating-unit case 120 as with the processing element 114 arranged inside the processing-unit case 110.

A liquid nozzle 125 for dripping the hygroscopic liquid toward the regenerating element 124 is arranged inside the regenerating-unit case 120 at a position above the regenerating element 124. A circulation circuit 126 for sending the hygroscopic liquid in the liquid tank 121 to the liquid nozzle 125, is formed outside the regenerating-unit case 120. A circulation pump 127, which is used as a regenerating-unit circulating means, for circulating the hygroscopic liquid is arranged in the circulation circuit 126. Moreover, a heat exchanger 134, which will be described below, and an auxiliary heat exchanger 129 are arranged in the circulation circuit 126 at a downstream portion of the circulation pump 117. The auxiliary heat exchanger 129, a pump 129a and a heat source 129b are arranged in an auxiliary circuit 129c. A medium in the auxiliary circuit 129c is cooled or heated by the heat source 129b. The medium circulates in the auxiliary circuit 129c by the pump 129a. By the auxiliary heat exchanger 129, the hygroscopic liquid is heat exchanged with medium. For example, one of cool water, a refrigerant, or hot water is used as the medium in the auxiliary circuit 129c.

A compressor 131 for compressing a refrigerant, the heat exchanger 132, a decompressing means 133 for decompressing and expanding the refrigerant (example for electronic controlled expansion valve), and the heat exchanger 134 are circularly-connected so that the heat pump unit 13 is configured. Both the heat exchangers 132, 134 are finned double-pipe countercurrent heat exchangers, for example. The heat exchanger 132 is configured such that heat is exchanged between the refrigerant and the hygroscopic liquid flowing through the circulation circuit 116, and the heat exchanger 134 is configured such that heat is exchanged between the refrigerant and the hygroscopic liquid flowing through the circulation circuit 126.

The heat pump unit 13 is configured such that a circulation direction of the refrigerant can be changed by switching a four-way valve or the like (not shown). The hygroscopic liquid can be heated in the heat exchanger 134 when the hygroscopic liquid is cooled in the heat exchanger 132, and the hygroscopic liquid can be cooled in the heat exchanger 134 when the hygroscopic liquid is heated in the heat exchanger 132.

The inside of the liquid tank 111 of the processing unit 11 communicates with the inside of the liquid tank 121 of the regenerating unit 12 through a communication portion 14. The hygroscopic liquid in the liquid tank 111 and the hygroscopic liquid in the liquid tank 121 flow mutually (that is, circulate between the liquid tanks 111, 121) so that a concentration of the hygroscopic liquid in the liquid tank 111 becomes the same with that in the liquid tank 121.

As shown in FIG. 1, the interior outlet ports 23 are formed in respective rooms such as a living room 102, a Japanese room 103, a bedroom 104, a child's room 105, and a study room 106. The interior inlet ports 32 are formed in internal communication areas such as a vestibule 107 and a bathroom 108, which communicate with the respective rooms through gap communication portions such as door undercut portions (not shown). Although only a part is shown in the drawing, an indoor unit 91, which is connected to an outdoor unit 92 of an air conditioner 90 through a refrigerant pipe, is arranged in the respective rooms such as the living room 102 as needed, and thereby the room equipped with the indoor unit 91 can be air-conditioned individually.

The intake duct 20 connects the processing unit 11 of the humidity controller 10 to the interior outlet port 23, that is, forms an air passage to the interior outlet port 23 from the processing unit 11. The intake duct 20 includes a vertical duct 24 extending in the vertical direction (in the present embodiment, extending in an up-and-down direction). The vertical duct 24 is formed by a pipe member made of resin (in the present embodiment, made of vinyl chloride resin). As shown in FIG. 1, the vertical duct 24 extends in a pipe shaft (not shown) inside an exterior wall 101 of the building 100 from the level of the processing unit 11 of the humidity controller 10 (refer to FIG. 2A) to an attic. An intake blower 40 is arranged in the intake duct 20 at a downstream portion of the vertical duct 24. The intake duct 20 is divided at a downstream portion of the intake blower 40 into a first-floor intake duct 25 and a second-floor intake duct 26. Each of the first-floor intake duct 25 and the second-floor intake duct 26 extends to the interior outlet ports 23 of each floor.

A return pipe 28, which communicates between the inside of the intake duct 20 and the inside of the processing-unit case 110, is arranged at a bottom end portion of the vertical duct 24. The return pipe 28 is configured to return the hygroscopic liquid in the intake duct 20, which is released from the processing unit 11, to the processing unit 11.

As shown in FIG. 2A, the intake duct 20 has a circular trap groove 27, which is formed such that a diameter of an inner wall of the trap groove 27 is enlarged, at the bottom end portion of the vertical duct 24. An upstream end of the return pipe 28 is connected to the trap groove 27. In contrast, a downstream end of the return pipe 28 is connected to the liquid tank 111 of the processing unit 11. The trap groove 27 and the return pipe 28 configure a recirculating means of the hygroscopic liquid in the present embodiment.

It is preferable that, even if an intake pressure in the return pipe 28 at a side of the trap groove 27 is lower than that at a side of the liquid tank 111, the hygroscopic liquid is recirculated stably by using a backflow preventing means such as a check valve in the return pipe 28 or by configuring such that an open end of the return pipe 28 at a side of the processing unit 11 opens in the hygroscopic liquid in the liquid tank 111, for example.

The recirculating means of the hygroscopic liquid is not limited to the configuration formed by the trap groove 27 and the return pipe 28. The intake duct 20 may be arranged such that an upstream portion of the vertical duct 24 is downwardly slanted toward the air outlet port 113 from the bottom end portion of the vertical duct 24, for example. Furthermore, the intake duct 20 may be configured such that the upstream portion of the vertical duct 24 extends in a horizontal direction and a recirculation guiding member, which is downwardly slanted toward the air outlet port 113 from the bottom end portion of the vertical duct 24, is arranged to extend in the extending upstream portion, for example.

The exhaust ducts 30 connected to the interior inlet ports 32 of the respective floors join together and the joined exhaust duct 30 extends to the regenerating unit 12 of the humidity controller 10 (refer to FIG. 2A) in the above-described pipe shaft (not shown). An exhaust blower 50 is arranged in the exhaust duct 30 at a downstream portion of a point, at which the exhaust ducts 30 join together.

Each of the intake blower 40 and the exhaust blower 50 may be a blower having a sirocco fan, for example. In FIG. 1, the intake blower 40 and the exhaust, blower 50 are separately arranged. However, by arranging the intake duct 20 and the exhaust duct 30 suitably, the intake blower 40 and the exhaust blower 50 may be housed in one case and share a drive motor portion.

In the present embodiment, the intake duct 20 and the intake pipe 21 correspond to an air supply passage that conducts air from the exterior inlet port 22 to the interior outlet port 23 of the building 100, and the exhaust duct 30 and the exhaust pipe 31 correspond to an air discharge passage that conducts air from the interior inlet port 32 of the building 100 to the exterior outlet port 33. Thus, the processing unit 11 of the humidity controller 10 is arranged in the air supply passage. Moreover, in the present embodiment, the vertical duct 24 corresponds to a vertically extending section that extends in the vertical direction to create an upflow of the intake air conducted from the processing unit 11 toward the interior outlet port 23.

As shown in FIG. 2A, the exhaust pipe 31 connected to the air outlet port 123 of the regenerating-unit case 120 has a vertically extending section that extends in the vertical direction to create an upflow of the discharge air conducted from the regenerating unit 12 toward the exterior outlet port 33 as with the intake duct 20. In the present embodiment, the exhaust pipe 31 has a portion used as a recirculating means of the hygroscopic liquid, which is downwardly slanted toward the air outlet port 123 from a bottom end portion of the vertically extending section. Furthermore, the exhaust air filter 331 arranged at the downstream end of the exhaust pipe 31 also has a function of trapping droplets of the hygroscopic liquid, which have passed through the vertically extending section of the exhaust pipe 31, other than a function of preventing the foreign object from entering the regenerating-unit case 120.

Next, the operation of the humidity control and ventilation system 1 will be described based on the above-described configuration.

The humidity control and ventilation system 1 of the present embodiment includes a control device (i.e., an ECU 60) and detecting means (i.e., an external temperature/humidity sensor 71 and an internal temperature/humidity sensor 72) that detect a temperature and humidity of the external air and a temperature and humidity of the internal air. The control device 60 as a controlling means is configured to control the operation of the humidity control and ventilation system 1 based on the temperature information and the humidity information of the external space and the internal space, which are detected by the respective detecting means 71, 72. FIG. 2B shows a control system of the humidity control and ventilation system 1. As shown in FIG. 2B, the ECU 60 is configured to operate the circulation pumps 117, 127, the blowers 40, 50, the compressor 131, the decompressing means 133, the pumps 119a, 129a, and the heat sources 119b, 129b (an auxiliary heat exchanger controller) based on the information of the sensors 71, 72.

When the external space is in conditions of high temperature and humidity, and thus dehumidification is required, the control device 60 operates the circulation pumps 117, 127 and the blowers 40, 50, and drives the compressor 131 and the decompressing means 133. Thus, the refrigerant circulates in the heat pump unit 13 in a counterclockwise direction in FIG. 2A, and the hygroscopic liquid is heated by the heat exchanger 134 and the hygroscopic liquid is cooled by the heat exchanger 132. When the capacity of the heat pump unit 13 is lower than target capacity, the control device 60 operates the pumps 119a, 129a and the heat sources 119b, 129b, and the auxiliary heat exchangers 119, 129 compensate for the shortage.

The intake air conducted from the exterior inlet port 22 contacts the low-temperature hygroscopic liquid when passing through the processing element 114 of the processing unit 11 of the humidity controller 10, and thereby the intake air is cooled and dehumidified. The intake air, which is cooled and dehumidified so that a temperature and humidity thereof are adjusted, is supplied by the intake blower 40 to the respective rooms such as the living room 102, the Japanese room 103, the bedroom 104, the child's room 105, and the study room 106 from the respective interior outlet ports 23 through the intake duct 20 made of resin.

The air in the respective rooms is conducted from the interior inlet ports 32 formed respectively in the vestibule 107 and the bathroom 108 through gaps such as door undercut portions of the rooms, and the air is sent by the exhaust blower 50 to the regenerating unit 12 of the humidity controller 10 through the exhaust duct 30 made of resin. The discharge air from the internal space contacts the high-temperature hygroscopic liquid when passing through the regenerating unit 12 of the humidity controller 10, and thereby the discharge air is heated and humidified. The discharge air that has passed through the regenerating unit 12 is exhausted from the exterior outlet port 33 to the external space.

In contrast, when the external space is in conditions of low temperature and humidity, and thus humidification is required, the control device 60 operates the circulation pumps 117, 127 and the blowers 40, 50, and drives the compressor 131 and the decompressing means 133. Thus, the refrigerant circulates in the heat pump unit 13 in a clockwise direction in FIG. 2A, and the hygroscopic liquid is heated by the heat exchanger 132 and the hygroscopic liquid is cooled by the heat exchanger 134. When the capacity of the heat pump unit 13 is lower than target capacity, the control device 60 operates the pumps 119a, 129a and the heat sources 119b, 129b, and the auxiliary heat exchangers 119, 129 compensate for the shortage.

The intake air conducted from the exterior inlet port 22 contacts the high-temperature hygroscopic liquid when passing through the processing element 114 of the processing unit 11 of the humidity controller 10, and thereby the intake air is heated and humidified. The intake air, which is heated and humidified so that a temperature and humidity thereof are adjusted, is supplied by the intake blower 40 to the respective rooms such as the living room 102, the Japanese room 103, the bedroom 104, the child's room 105, and the study room 106 from the respective interior outlet ports 23 through the intake duct 20 made of resin.

The air in the respective rooms is conducted from the interior inlet ports 32 formed respectively in the vestibule 107 and the bathroom 108 through the gaps such as the door undercut portions of the rooms, and the air is sent by the exhaust blower 50 to the regenerating unit 12 of the humidity controller 10 through the exhaust duct 30. The discharge air from the internal space contacts the low-temperature hygroscopic liquid when passing through the regenerating unit 12 of the humidity controller 10, and thereby the discharge air is cooled and dehumidified. The discharge air that has passed through the regenerating unit 12 is exhausted from the exterior outlet port 33 to the external space.

In this manner, a latent heat process of the external air that is to be conducted by ventilation is performed in the processing unit 11 of the humidity controller 10 in advance, and thereby increasing of an air-conditioning load of the air conditioner 90 can be limited. In particular, since dehumidifying operation frequency of the air conditioner 90 is decreased in the season when the external space is in conditions of high temperature and humidity, a temperature of a low-pressure side heat exchanger of the indoor unit 91 is increased and operation with high-energy efficiency can be performed.

In a place where a person often stays in, for example, the living room 102 equipped with the indoor unit 91 of the air conditioner 90, the air conditioner 90 is operated with high efficiency by specializing in a sensible heat process and thereby a comfortable space can be achieved with saving energy.

Moreover, other than the living room 102 equipped with the indoor unit 91 of the air conditioner 90, in another room that is not equipped with the indoor unit 91 of the air conditioner 90, the rooms such as the vestibule 107 and the bathroom 108, and a space in which an air conditioner is not operated, a sense of warmth can be improved compared to the case where humidity control and ventilation are not performed.

According to the humidity control and ventilation system 1 of the present embodiment, the vertical duct 24 is arranged in the intake duct 20 that connects the processing unit 11 to the interior outlet port 23. Therefore, even if droplets of the hygroscopic liquid are taken in the intake air when the intake air passes through the processing unit 11 of the humidity controller 10, flying of the droplets of the hygroscopic liquid can be suppressed by the gravity and the droplets can be prevented from reaching the interior outlet port 23.

In the present embodiment, the building 100 is a two-story building, and the vertical duct 24 extends from the level of the processing unit 11 of the humidity controller 10 placed in the external space to the attic of the building 100. The intake duct 20 is divided into the first-floor intake duct 25 and the second-floor intake duct 26 at the attic. Accordingly, the vertical duct 24 can obtain a length of, for example, 5 m or more, and the droplets of the hygroscopic liquid that reach the interior outlet port 23 can be reliably suppressed.

Furthermore, by forming the vertical duct 24, a liquid filter for trapping the droplets of the hygroscopic liquid or a complicated gas-liquid separating device does not need to be arranged. Therefore, duct pressure loss can be reduced, and a compact humidity control and ventilation system can be realized at low cost.

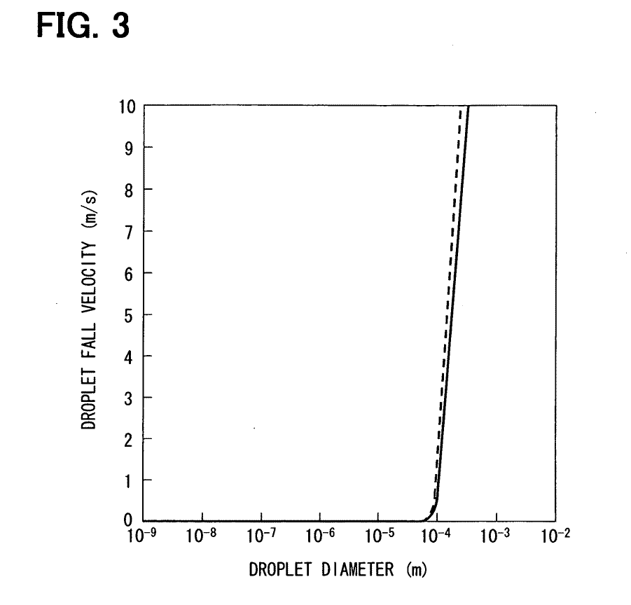

FIG. 3 is a graph showing a relation between a droplet diameter and a droplet fall velocity of lithium chloride aqueous solution as one example of the hygroscopic liquid of the humidity control and ventilation system 1 of the present embodiment. Values of a viscosity of air, a density of air, a density of the hygroscopic liquid are substituted to Stokes equation, and the relation between the droplet diameter and the droplet fall velocity of the spherical droplet is calculated. The density of the hygroscopic liquid changes with temperature relatively a lot. Thus, in FIG. 3, the relation in the case where the density of the hygroscopic liquid is 1050 kg/m³ when the hygroscopic liquid is heated to be in a high-temperature state is shown by the solid line, and the density of the hygroscopic liquid is 1250 kg/m³ when the hygroscopic liquid is cooled to be in a low-temperature state is shown by the dashed line.

As is clear from FIG. 3, when a flow velocity in the vertical duct 24 is 4 m/s, a droplet having a diameter of 330 to 360 μm or more cannot ascend in the vertical duct 24. Moreover, when a flow velocity in the vertical duct 24 is 2 m/s, a droplet having a diameter of 230 to 255 μm or more cannot ascend in the vertical duct 24. Therefore, large droplets that have a significant influence if a large quantity of droplets fly (for example, large droplets that considerably shorten a period of time for maintenance when the liquid filter is arranged) can be removed by the vertical duct 24 without increasing pressure loss.

According to the explanation using FIG. 3, minute droplets each having a relatively small diameter can ascend with the upward intake air flow in the vertical duct 24. In the present embodiment, by setting an inner diameter of the vertical duct 24 to have a suitable value, the minute droplets are made to adhere to an inner wall surface of the vertical duct 24, and are prevented from flying downstream.

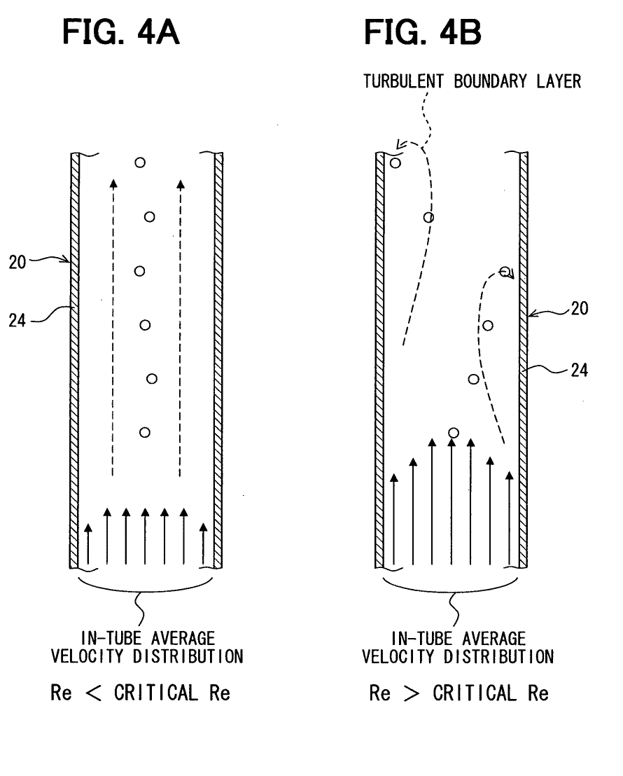

FIGS. 4A and 4B are schematic diagrams each showing a flow in the vertical duct 24 when droplets of the hygroscopic liquid mix into air, in the case where Reynolds number Re is smaller than critical Reynolds number (about 2000 to 4000) (shown in FIG. 4A), and in the case where Reynolds number Re is larger than critical Reynolds number (shown in FIG. 4B). As shown in FIG. 4A, in the case where Reynolds number of the flow in the duct is smaller than critical Reynolds number, the flow in the duct becomes a laminar flow, and is in a droplets dispersion state called as axial-centered distribution in which the droplets of the hygroscopic liquid having large specific gravity compared to air tend to flow with centered around the central axis of the duct. As shown in FIG. 4B, in the case where Reynolds number of the flow in the duct is larger than critical Reynolds number, distribution of droplets of the hygroscopic liquid is diffused outward in a radial direction by turbulence of a turbulent boundary layer, and the droplets of the hygroscopic liquid come close to the wall surface of the vertical duct 24.

Accordingly, in the present embodiment, by setting the inner diameter of the vertical duct 24 such that Reynolds number of the flow in the vertical duct 24 is larger than critical Reynolds number, the turbulent boundary layer is generated and the droplets of the hygroscopic liquid can be diffused outward in the radial direction from the central axis of the duct. Thus, the probability that the droplets adhere to the wall surface of the vertical duct 24 by the collision with the inner surface of the vertical duct 24 is increased. Since a viscosity of lithium chloride aqueous solution is relatively high, lithium chloride aqueous solution is hard to move downstream (i.e., upward in the drawing) in the intake air flow when lithium chloride aqueous solution has adhered to the wall surface. Thus, lithium chloride aqueous solution can be reliably prevented from reaching the interior outlet port 23.

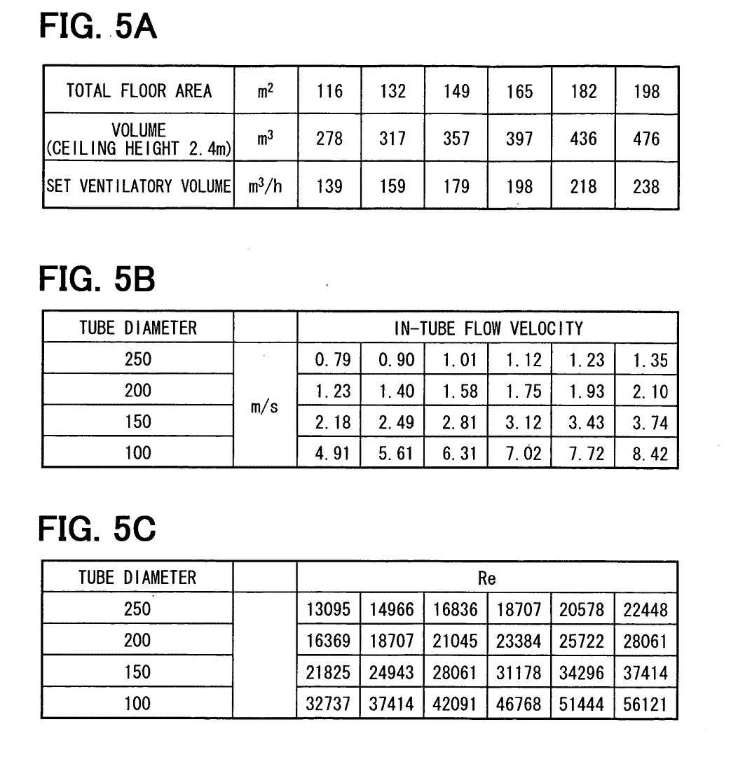

FIGS. 5A to 5C show, in the case where a total floor area of a building is 116 m² to 198 m², ventilatory volume, a tube diameter of the duct (i.e., a duct inner diameter) and an in-tube flow velocity, and Reynolds number Re of a flow in the tube, respectively. FIG. 5A shows a volume of the internal space, and a set ventilatory volume (i.e., a desired value of the ventilatory volume) in the case where 50% of the volume is ventilated per hour, with respect to the total floor area. FIG. 5B shows the in-tube flow velocity for achieving the above set ventilatory volume in each of typical tube diameters. FIG. 5C shows Reynolds number Re in the above in-tube flow velocity in each of the typical tube diameters.

As is clear from FIGS. 5A to 5C, in the case where the total floor area of the building is 116 m² to 198 m², Reynolds number Re can achieve a safety factor three times or more of critical Reynolds number when the inner diameter of the vertical duct 24 is in the range of 100 to 250 mm.

Since the vertical duct 24 is made of resin, even if lithium chloride aqueous solution as the hygroscopic liquid adheres to the inner surface of the vertical duct 24, the vertical duct 24 is not adversely affected, for example, is not corroded.

The hygroscopic liquid that is prevented from flying in the vertical duct 24, that is, the hygroscopic liquid that does not ascend in the vertical duct 24 and the hygroscopic liquid that adheres to the inner surface of the vertical duct 24 and falls in the vertical duct 24, is trapped by the circular trap groove 27 formed at the bottom end portion of the vertical duct 24, and can be returned to the liquid tank 111 of the processing unit 11 through the return pipe 28. Therefore, decreasing of the hygroscopic liquid in the humidity controller 10 can be prevented.

Moreover, since the intake blower 40 is arranged at the downstream portion of the vertical duct 24, adhering of the droplets of the hygroscopic liquid to the intake blower 40 can be suppressed. Thus, a failure of the intake blower 40 by corrosion or the like can be prevented.

Furthermore, since the vertical duct 24 is arranged in the pipe shaft inside the exterior wall 101 of the building 100, the intake air whose temperature and humidity are adjusted by the humidity controller 10 can be prevented from generating heat loss due to the influence of external temperature. That is, the vertical unit 24 can be prevented from being exposed to the external air. Thus, the air, which is humidity controlled by the processing unit 11, is not affected by the external temperature while ascending in the vertical duct 24.

Moreover, air in the building 100 is conducted from the interior inlet port 32 and is exhausted from the exterior outlet port 33 through the regenerating unit 12 of the humidity controller, 10. Therefore, by using the discharge air from the internal space, whose quality is higher than that of the external air (that is, the discharge air from the internal space is in conditions of low temperature and humidity in the summer season, and is in conditions of high temperature and humidity in the winter season, compared to the external air), the moisture absorbing-releasing capacity of the hygroscopic liquid in the humidity controller 10 can be regenerated (that is, moisture is released from the hygroscopic liquid in the summer season, and moisture is absorbed by the hygroscopic liquid in the winter season). Thermal energy of the discharge air is used as regenerating energy of the humidity controller 10, and thereby a heat recovery function (i.e., recovering of the thermal energy) can be obtained. That is, the thermal energy of the discharge air from the internal space can be used as energy for the regenerating process of the hygroscopic liquid in the regenerating unit 12. Therefore, the thermal energy in the internal space can be recovered even if the internal space is ventilated.

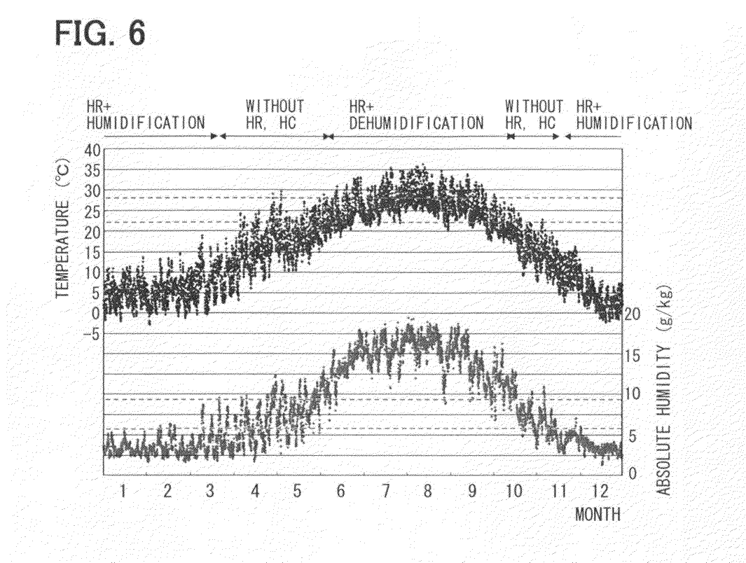

FIG. 6 shows data of the external temperature and the humidity in Nagoya. In FIG. 6, the heat recovery is indicated by HR, and the humidity control is indicated by HC. As shown in FIG. 6, in the case where desired air-conditioned temperature is set to be 22 to 28° C. and desired absolute humidity is set to be 6 to 9 g/kg, for example, there is a period in which the heat recovery is unnecessary when humidity control is unnecessary depending on seasons (i.e., there is no advantage even if heat is recovered from the discharge air from the internal space).

In the humidity control and ventilation system 1 of the present embodiment, with or without the humidity control and with or without the heat recovery can be easily controlled by selecting on or off of the operation of the humidity controller 10. Thus, compared to the case where heat is exchanged between the intake air and the discharge air in a heat exchanger, the pressure loss in ventilation when the humidity control and the heat recovery are not performed becomes smaller, and ventilation can be performed with saving energy throughout one year. Furthermore, compared to the case where a heat exchanger that performs heat exchange between the intake air and the discharge air is arranged and passages for the intake air and the discharge air that bypass the heat exchanger when the heat recovery is unnecessary are formed, the humidity control and ventilation system 1 can be reduced in size by simplifying the configuration thereof. By stopping at least one of the circulation pumps 117, 127 of the humidity controller 10, the heat recovery is stopped, and thus, power for the pumps can be reduced.

In particular, enthalpy of the intake air conducted from the exterior inlet port 22 and enthalpy of the discharge air conducted from the interior inlet port 32 are calculated and compared to each other, based on the temperature information and the humidity information of the external space and the internal space, which are detected by the respective detecting means 71, 72, and based on pressure information of the external air and the internal air as necessary. When a difference of the enthalpies is equal to or lower than a predetermined setting value, at least one of the circulation pumps 117, 127 of the humidity controller 10 is stopped. At this time, the operation of the compressor 131 may be stopped.

The present embodiment is not limited to the case where the enthalpy of the external air and the enthalpy of the internal air are calculated and a difference of the enthalpies is compared. The present embodiment may be configured as follows. A difference of physical quantities corresponding to the enthalpy of the external air and the enthalpy of the internal air is compared, and at least one of the circulation pumps 117, 127 of the humidity controller is stopped when the difference of the physical quantities is equal to or lower than a predetermined setting value. As an example of the physical quantity, a temperature or humidity can be used.

As described above, when the difference of the enthalpies or the difference of the physical quantities between the external air and the internal air is equal to or lower than a predetermined value based on at least the temperature and the humidity of the external space and those of the internal space, at least one of the circulation pumps 117, 127 is stopped. Therefore, even if the humidity control and ventilation system 1 does not have the vertical duct 24 the above-described effect can be obtained.

Furthermore, each of the intake blower 40 and the exhaust blower 50 is a blower that is connected to a duct, that is, a duct fan, and can secure a predetermined ventilatory volume. In the present embodiment, the intake blower 40 and the exhaust blower 50 are separately arranged. However, the intake blower 40 and the exhaust blower 50 can be housed in one case by arranging the ducts suitably. Therefore, a fan case, a power source, and a controller can be reduced in size at low cost.

### Second Embodiment

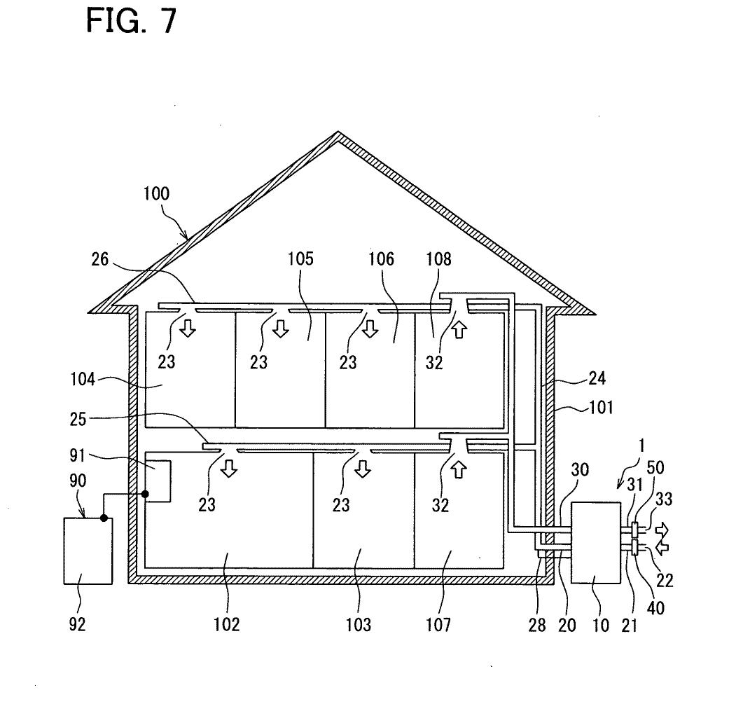

Next, the second embodiment of the present invention will be described with reference to FIG. 7.

A configuration of the intake duct 20 and arranged positions of the intake blower 40 and the exhaust blower 50 in the second embodiment are different from those of the first embodiment. It is to be noted that the component which is the same with that in the first embodiment is designated by the same reference numeral and a description thereof will not be repeated.

As shown in FIG. 7, in the present embodiment, the intake duct 20 is branched to the first-floor intake duct 25 in the middle of the vertical duct 24. Moreover, the intake blower 40 is arranged in the intake pipe 21 at an upstream side of the processing unit 11, and the exhaust blower 50 is arranged in the exhaust pipe 31 at a downstream side of the regenerating unit 12.

Since the first-floor intake duct 25 is branched in the middle of the vertical duct 24, the first-floor intake duct 25 does not need to be extended downward from the attic as shown in the first embodiment. Thus, the first-floor intake duct 25 can be shortened and work for sending air can be reduced.

Furthermore, since the intake blower 40 is arranged at the upstream side of the processing unit 11, the droplets of the hygroscopic liquid in the humidity controller 10 can be reliably prevented from adhering to the intake blower 40. Since the exhaust blower 50 is arranged at the downstream side of the regenerating unit 12, the intake blower 40 and the exhaust blower 50 are arranged closely to each other. Thus, a case for a blower, a power source, and a control board can be shared between the intake blower 40 and the exhaust blower 50, and can be reduced in size at low cost.

The present embodiment may be configured as follows. The exhaust blower 50 is arranged in the exhaust duct 30 at the downstream portion (i.e., at a position adjacent to the regenerating unit 12 at the upstream side of the regenerating unit 12) and the ducts are arranged suitably, such that the intake blower 40 and the exhaust blower 50 are arranged closely to each other. Accordingly, the droplets of the hygroscopic liquid in the humidity controller 10 can also be reliably prevented from adhering to the exhaust blower 50.

### Third Embodiment

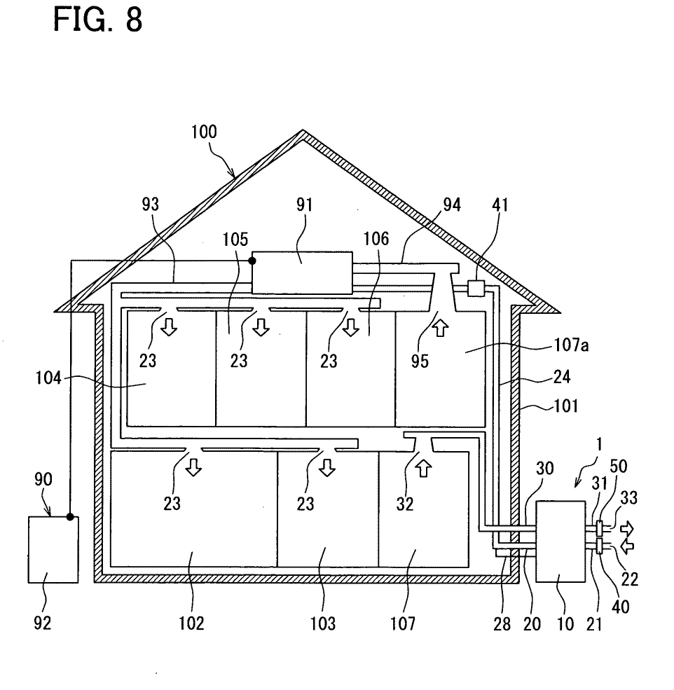

Next, the third embodiment of the present invention will be described with reference to FIG. 8.

The third embodiment is different from the first and second embodiments in that a duct-type air conditioner, which conditions air in multiple rooms simultaneously, that is, a central air conditioner, is used as the air conditioner 90 of the building in place of a room air conditioner, which conditions air in each of the rooms individually. It is to be noted that the component which is the same with that in the first and second embodiments is designated by the same reference numeral and a description thereof will not be repeated.

As shown in FIG. 8, in the present embodiment, the indoor unit 91 for the central air conditioner is arranged in the attic, and an air-conditioning intake duct 93 is extended from the indoor unit 91 to the interior outlet ports 23 formed in the respective rooms such as the living room 102, the Japanese room 103, the bedroom 104, the child's room 105, and the study room 106.

The downstream end of the intake duct 20 is connected to the indoor unit 91, and the intake air, which is humidity controlled by the processing unit 11 of the humidity controller 10, is supplied to the indoor unit 91. An intake air filter 41 as a filter member is arranged in the intake duct 20 at the downstream portion of the vertical duct 24, and the hygroscopic liquid can be reliably prevented from reaching the indoor unit 91. A stair portion 107a of the vestibule 107 has an air-conditioning inlet port 95. The air-conditioning inlet port 95 is the upstream end of an air-conditioning return duct 94, and the downstream end of the air-conditioning return duct 94 is connected to the indoor unit 91.

The airflow in the humidity control and ventilation system 1 of the present embodiment will be described. The intake air conducted from the exterior inlet port 22 passes through the processing unit 11 of the humidity controller 10 by the intake blower 40, ascends to the attic through the vertical duct 24, and passes through the intake air filter 41, and then, the intake air flows into the indoor unit 91.

Air in the building 100 conducted from the air-conditioning inlet port 95, which is formed in the stair portion 107a of the vestibule 107, and the intake air that has passed through the processing unit 11 of the humidity controller 10 are mixed in the indoor unit 91 (for example, the intake air and air-conditioning return air from the air-conditioning inlet port 95 are mixed such that a flow ratio thereof is 1:5 to 10). The mixed air is temperature controlled, and then, is supplied to the respective rooms from the interior outlet ports 23 through the air-conditioning intake duct 93. The air supplied to the respective rooms passes through the door undercut portions or the like (not shown) and the air in the first floor and the air in the second floor are gathered. The gathered air is conducted from the air-conditioning inlet port 95 and returns to the indoor unit 91 through the air-conditioning return duct 94.

The outdoor unit 92 of the central air conditioner is connected to the indoor unit 91 of the central air conditioner through the refrigerant pipe so that the central air conditioner is configured.

The air in the building 100 is conducted from the interior inlet port 32, which is formed in the vestibule 107, a bathroom or the like, passes through the exhaust duct 30 and the regenerating unit 12 of the humidity controller 10, and is exhausted to the external space from the exterior outlet port 33 by the exhaust blower 50.

According to the humidity control and ventilation system 1 of the present embodiment, almost all of the droplets of the hygroscopic liquid can be removed out of the intake air in the vertical duct 24. Thus, the hygroscopic liquid that may adhere to the intake air filter 41, which is arranged at the downstream portion of the vertical duct 24, can be extremely reduced. Therefore, a period of time for maintenance of the intake air filter 41 can be extended, and increasing of pressure loss of the intake air filter 41 due to adhesion of the hygroscopic liquid can be suppressed.

Moreover, the air in the building 100 conducted from the air-conditioning inlet port 95 and the intake air that has passed through the processing unit 11 of the humidity controller 10 are mixed in the indoor unit 91, and the mixed air is temperature controlled, and then, is supplied to the respective rooms. Therefore, increasing of an air-conditioning load for the external air due to ventilation and decreasing of efficiency due to a dehumidifying operation of the air conditioner 90 can be suppressed.

In particular, since a central air conditioner conditions air in an entire building, an air conditioner with large capacity is generally needed. However, a part for the latent heat process of the external air (for example, about one-half of a load for humidity control and air-conditioning in the summer season) is preprocessed in the humidity controller 10, and thereby a compact and high-efficient air conditioner can be used. Conventionally, since the inside of a building is processed by air that is temperature conditioned by one indoor unit for a central air conditioner, differences in preferences of men and women of all ages have easily become a problem. However, by combining the humidity controller 10, air conditioning that widely suits preferences of users can be performed, compared to the case where air conditioning is performed based on only the temperature. For example, high-temperature and low-humidity cooling or low-temperature and high-humidity heating can be easily performed.

### Fourth Embodiment

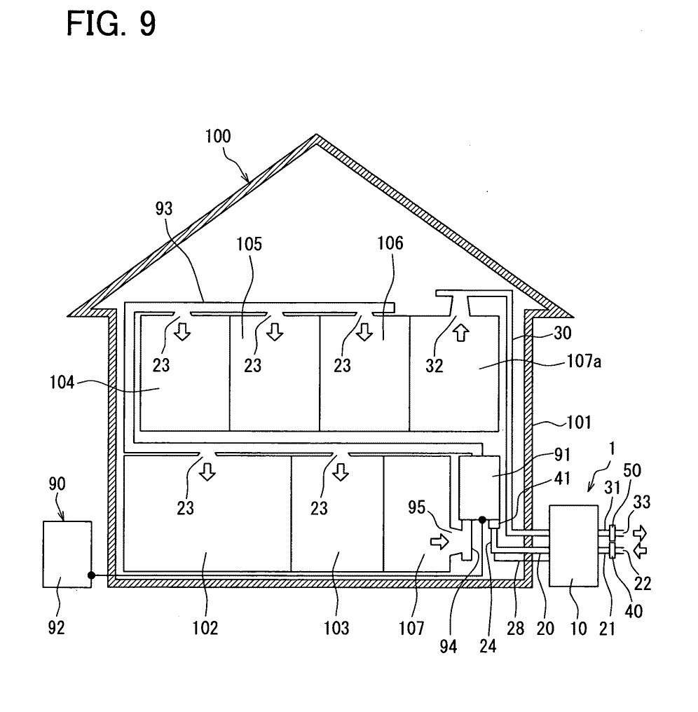

Next, the fourth embodiment of the present invention will be described with reference to FIG. 9.

An arranged position of the indoor unit 91 for the central air conditioner in the fourth embodiment is different from that in the third embodiment. It is to be noted that the component which is the same with that in the first to third embodiments is designated by the same reference numeral and a description thereof will not be repeated.

As shown in FIG. 9, in the present embodiment, the indoor unit 91 for the central air conditioner is arranged in the first floor of the building 100 by using a space below a stair. Also in the present embodiment, the intake air that has passed through the processing unit 11 of the humidity controller 10 is conducted into the indoor unit 91 through the vertical duct 24 of the intake duct 20. The intake air filter 41 is arranged in the vertical duct 24 at the most downstream portion adjacent to and in front of the indoor unit 91.

Therefore, a mixing ratio of the droplets of the hygroscopic liquid in the intake air can be reduced by the vertical duct 24, and the period of time for maintenance of the intake air filter 41 can be extended. In order to improve the effect of the vertical duct 24, if the vertical duct 24 is extended above the indoor unit 91 and is connected to the indoor unit 91 such that the intake air is conducted thereto from above, the effect of the vertical duct 24 can be further improved.

Although a detailed description is omitted in the first to fourth embodiments, arbitrary structures can be applied to connection structures of the intake duct 20 or the air-conditioning intake duct 93 to the interior outlet ports 23.

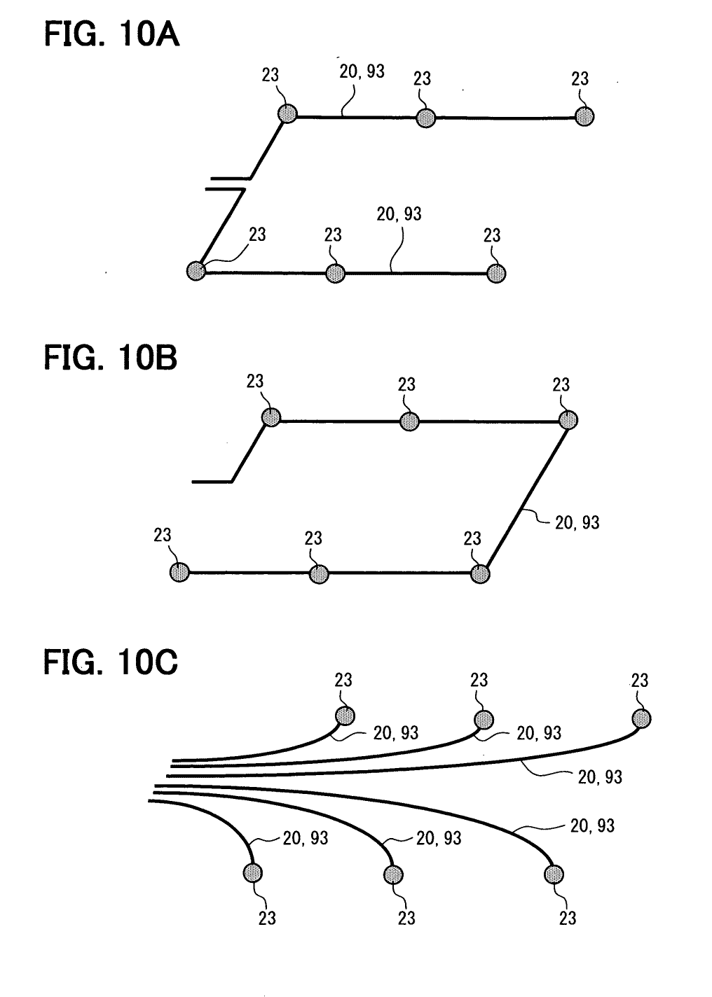

For example, a double-duct system may be applied as shown in FIG. 10A, or a single-duct system may be applied as shown in FIG. 10B. Furthermore, a multiple-duct system, in which multiple ducts respectively correspond to the interior outlet ports 23, may be applied as shown in FIG. 10C. Alternatively, the above systems may be arbitrary combined.

### Other Embodiments

Hereinbefore, the preferred embodiments of the present invention are described. However, the present invention is not limited to the above-described embodiments, and various changes can be made without departing from the scope of the invention.

In the above-described embodiments, the vertically extending section of the intake duct 20 is the vertical duct 24. However, the vertically extending section may be slanted as long as the vertically extending section extends in the vertical direction and the intake air that has passed through the processing unit 11 flows upward.

In the above-described embodiments, the trap groove 27 that configures a part of the recirculating means of the hygroscopic liquid is arranged at the bottom end portion of the vertical duct 24. However, the trap groove 27 may be located on a slightly upper side of the bottom end portion of the vertical duct 24 as long as most of the hygroscopic liquid can be recirculated from the vertical duct 24.

In the above-described embodiments, the vertical duct 24 extends in the pipe shaft inside the exterior wall 101 of the building 100. However, the vertical duct 24 may be arranged between the exterior wall 101 and insulating material arranged inside the exterior wall 101 or in the insulating material arranged inside the exterior wall 101 as long as the vertical duct 24 is located inside the exterior wall 101 configuring the building 100.

In the above-described embodiments, a detailed description of material for the intake blower 40 and the exhaust blower 50 is omitted. However, it is preferable that, when the intake blower 40 is arranged at a downstream side of the processing unit 11 in an intake air flow and the exhaust blower 50 is arranged at an upstream side of the regenerating unit 12 in a discharge air flow, both the blowers 40, 50 are made of resin material other than the respective drive motor portions.

In the above-described embodiments, the intake pipe 21 is connected to the air inlet port 112 of the processing unit 11, and the exhaust pipe 31 is connected to the air outlet port 123 of the regenerating unit 12. However, the air inlet port 112 and the air outlet port 123 may not be formed. That is, the air inlet port 112 of the processing unit 11 may be used as an exterior inlet port, and the air outlet port 123 of the regenerating unit 12 may be used as an exterior outlet port.

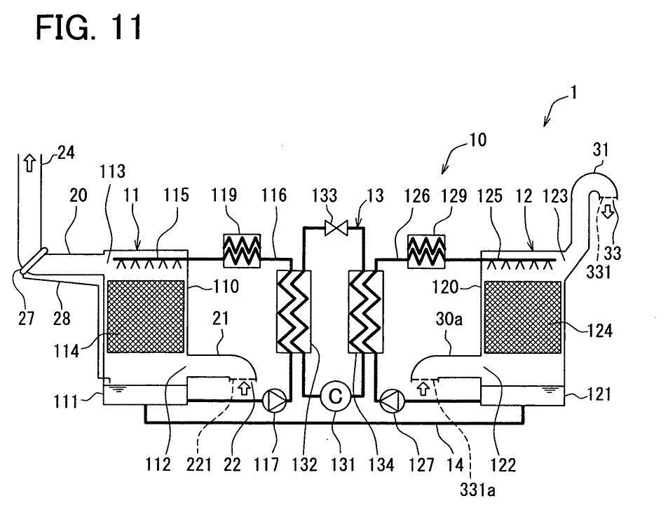

In the above-described embodiments, the air passing through the regenerating unit 12 is the discharge air from the internal space. However, if the heat recovery from the discharge air is unnecessary, the air passing through the regenerating unit 12 may be external air. As shown in FIG. 11; a regenerating-side intake pipe 30a that conducts the external air may be connected to the air inlet port 122 of the regenerating unit 12, and an intake air filter 331a may be arranged in the regenerating-side intake pipe 30a (in the example shown by FIG. 11, at the upstream end thereof).

In the above-described embodiments, the processing unit 11 of the humidity controller 10 can perform both the absorbing process and the releasing process, and performs either of the absorbing process or the releasing process in accordance with conditions such as an external environment. However, the processing unit 11 may perform at least one of the absorbing process and the releasing process.

In the above-described embodiments, the humidity controller 10 of the humidity control and ventilation system 1 includes the regenerating unit 12. However, the humidity controller 10 without a regenerating unit can be applied to the present invention.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A humidity control and ventilation system for a building, comprising:
an air supply passage configured to conduct intake air from an exterior inlet port, which is located at an outside of the building, to an interior outlet port, which is located at an inside of the building;
an air discharge passage configured to conduct discharge air from an interior inlet port, which is located at the inside of the building, to an exterior outlet port, which is located at the outside of the building; and
a processing unit that is disposed in the air supply passage and stores a hygroscopic liquid, wherein the processing unit performs at least one of:
an absorbing process, in which the hygroscopic liquid absorbs moisture from the intake air conducted through the air supply passage; and
a releasing process, in which the hygroscopic liquid releases moisture into the intake air conducted through the air supply passage, wherein:
the air supply passage includes an intake duct that is located between the processing unit and the interior outlet port; and
the intake duct includes a vertically extending section, which extends in a vertical direction to create an upflow of the intake air conducted from the processing unit toward the interior outlet port.

2. The humidity control and ventilation system according to claim 1, wherein
an inner diameter of the vertically extending section is set such that Reynolds number becomes larger than critical Reynolds number when the intake air flows from the processing unit to the interior outlet port so as to ventilate an internal space of the building at a predetermined volume.

3. The humidity control and ventilation system according to claim 1, further comprising
a recirculating means configured to recirculate the hygroscopic liquid to the processing unit from a substantially bottom end portion of the vertically extending section.

4. The humidity control and ventilation system according to claim 1, wherein
the vertically extending section is constructed of a pipe member made of resin.

5. The humidity control and ventilation system according to claim 1, wherein
the vertically extending section is arranged inside an exterior wall configuring the building.

6. The humidity control and ventilation system according to claim 1, further comprising
a filter member arranged in the intake duct at a downstream portion of the vertically extending section and configured to trap the hygroscopic liquid.

7. The humidity control and ventilation system according to claim 1, further comprising
an intake blower arranged in the intake duct at a downstream portion of the vertically extending section and configured to conduct the intake air into the air supply passage.

8. The humidity control and ventilation system according to claim 1, further comprising
a regenerating unit configured to perform a regenerating process that regenerates moisture absorbing-releasing capacity of the hygroscopic liquid, wherein
a hygroscopic liquid in the regenerating unit releases moisture into air when the processing unit performs the absorbing process and the hygroscopic liquid in the regenerating unit absorbs moisture from air when the processing unit performs the releasing process.

9. The humidity control and ventilation system according to claim 8, wherein
the regenerating unit is inserted in the air discharge passage and is configured such that moisture is released into the discharge air from the hygroscopic liquid or moisture is absorbed by the hygroscopic liquid from the discharge air.

10. The humidity control and ventilation system according to claim 9, further comprising:
a processing-unit circulating means configured to circulate the hygroscopic liquid in the processing unit to facilitate the absorbing process and the releasing process; and
a regenerating-unit circulating means configured to circulate the hygroscopic liquid in the regenerating unit to facilitate the regenerating process, wherein
at least one of the processing-unit circulating means and the regenerating-unit circulating means is stopped when a difference of enthalpies or physical quantities corresponding to the enthalpies between external air and internal air is equal to or lower than a predetermined value based on a temperature and humidity of an external space and a temperature and humidity of an internal space.
